(19) United States
(12) Patent Application Publication
(10) Pub. No.: US 2003/0089146 A1
(43) Pub. Date: May 15, 2003

(54) Quick release assembly

(76) Inventor: Michael L. Denby, Scottsdale, AZ (US)

Correspondence Address: Michael W. Goltry, PARSONS & GOLTRY, Suite 260, 340 East Palm Lane, Phoenix, AZ, 85004, US

(21) Appl. No.: 10/010,361

(22) Filed: Nov. 13, 2001

(51) Int. Cl. E05B 71/00; B62H 5/00

(52) U.S. Cl. 70/233

(57) ABSTRACT

A quick release assembly includes a handle having a key and a piston having a bore. A cam is held by a cap for rotation in the bore. One of the opposing ends of the cam has a keyway that capable of receiving the key. A catch assembly is disposed with the key and the keyway, which is capable of securing the key to the cam in response to receipt of the key by the keyway.

### FIELD OF THE INVENTION

This invention relates to quick release assemblies for attaching a removable part to a frame and to quick release hub assemblies for bicycles.

### BACKGROUND OF THE INVENTION

Many road and mountain bikes incorporate wheels having hubs that are furnished with quick release assemblies that are useful for quickly attaching and detaching the wheels to and from the bicycle frame. Quick release assemblies are also utilized for seat posts and other removable components of bicycles. Most quick release assemblies incorporate a hand-operated lever that interacts with a cam, securing and releasing, for instance, the hub to and from the fork of a bicycle frame in response to operation of the lever. Because quick release assemblies allow removable components such as wheels to be removed from a bicycle frame very quickly, such removable components, especially wheels, are often stolen. Although skilled artisans have devoted considerable effort toward improving the structure and function of quick release assemblies, relatively little effort has been directed toward quick release assemblies that are designed to resist unwanted and unauthorized operation.

Thus, there is a need for a new and improved quick release assembly that is easy to make, easy to use, inexpensive and highly efficient and that incorporates unique features that prevent unwanted and unauthorized operation.

### SUMMARY OF THE INVENTION

The above problems and others are at least partially solved and the above purposes and others realized in new and improved preferred embodiments of an invention that relate to a new and useful quick release assembly. One preferred embodiment of the invention is a device that includes a handle having a key and a piston having a bore. A cam includes ends that are held by a cap for rotation in the bore. The piston is capable of reciprocating in the cap, and one of the ends of the cam includes a keyway that is capable of receiving the key. The device includes a catch assembly that is capable of catching the key to the keyway. The catch assembly includes a protuberance carried by the cam at the keyway and a detachably engageable recess carried by the key, and this arrangement can be reversed. The protuberance is biased into the keyway and the keyway is eccentric relative to the cam. The piston is attached to a hub, which is attached to a wheel and to a bicycle frame.

Another preferred embodiment of the invention is a device that includes a handle having a key and a piston that is attached to an axle reciprocated to a hub. A bore passes through the piston. A cam includes ends that are held by a cap for rotation in the bore. The piston is capable of reciprocating in the cap, and one of the ends of the cam includes a keyway that is capable of receiving the key. The device includes a catch assembly that is capable of catching the key to the keyway. The catch assembly includes a protuberance carried by the cam at the keyway and a detachably engageable recess carried by the key, and this arrangement can be reversed. The protuberance is biased into the keyway and the keyway is eccentric relative to the cam. Further to this embodiment, the hub is also attached to a wheel and to a bicycle frame.

Yet another preferred embodiment of the invention is a device that includes a handle having a key and a piston that is attached to an axle reciprocated to a hub attached to a bicycle wheel. A bore passes through the piston. A cam includes ends that are held by a cap for rotation in the bore. The piston is capable of reciprocating in the cap, and one of the ends of the cam includes a keyway that is capable of receiving the key. The device includes a catch assembly that is capable of catching the key to the keyway. The catch assembly includes a protuberance carried by the cam at the keyway and a detachably engageable recess carried by the key, and this arrangement can be reversed. The protuberance is biased into the keyway and the keyway is eccentric relative to the cam. Further to this embodiment, the hub is also attached to a bicycle frame.

A further preferred embodiment of the invention is a device that includes a handle having a key and a piston having a bore. A cam includes ends that are held by a cap for rotation in the bore. The piston is capable of reciprocating in the cap, and one of the ends of the cam includes a keyway that is capable of receiving the key. The device includes a catch assembly that is capable of catching the key to the keyway. In this embodiment, the catch assembly is a magnetic attraction between the cam and the key. The cam is fabricated of magnetic material and the key is fabricated of iron or steel and this can be reversed. The cam and the key can each be fabricated of magnets if desired. Further to this embodiment, the piston is attached to a hub, which is attached to a wheel and to a bicycle frame.

Yet a further preferred embodiment of the invention is a device that includes a handle having a key and a piston that is attached to an axle reciprocated to a hub. A bore extends through the piston. A cam includes ends that are held by a cap for rotation in the bore. The piston is capable of reciprocating in the cap, and one of the ends of the cam includes a keyway that is capable of receiving the key. The device includes a catch assembly that is capable of catching the key to the keyway. In this embodiment, the catch assembly is a magnetic attraction between the cam and the key. The cam is fabricated of magnetic material and the key is fabricated of iron or steel and this can be reversed. The cam and the key can each be fabricated of magnets if desired. Further to this embodiment, the hub is also attached to a wheel and to a bicycle frame.

Still a further preferred embodiment of the invention is a device that includes a handle having a key and a piston that is attached to an axle reciprocated to a hub that is attached to a bicycle wheel. A bore extends through the piston. A cam includes ends that are held by a cap for rotation in the bore. The piston is capable of reciprocating in the cap, and one of the ends of the cam includes a keyway that is capable of receiving the key. The device includes a catch assembly that is capable of catching the key to the keyway. In this embodiment, the catch assembly is a magnetic attraction between the cam and the key. The cam is fabricated of magnetic material and the key is fabricated of iron or steel and this can be reversed. The cam and the key can each be fabricated of magnets if desired. Further to this embodiment, the hub is also attached to a bicycle frame.

### BRIEF DESCRIPTION OF THE DRAWINGS

Referring to the drawings:

FIG. 1 is a perspective view of a quick release assembly, in accordance with the principle of the invention, the quick release assembly disposed with a hub that is attached to a wheel and to a frame, each partially depicted;

FIG. 2 is a sectional view of the quick release assembly of FIG. 1, the quick release assembly including a handle having a key, a piston having a bore and a cam held by a cap for rotation in the bore and having a keyway that is capable of receiving the key;

FIG. 3 is an exploded perspective view of the quick release assembly of FIGS. 1 and 2;

FIG. 4 is a side elevation of the handle of FIG. 3, the opposite side elevation being a mirror image thereof;

FIG. 5 is a bottom plan of the handle of FIG. 3;

FIG. 6 is an exploded perspective view of the cam of FIG. 3 depicting elements of a catch assembly of the invention;

FIG. 7 is an exploded perspective view of the elements of the catch assembly depicted in FIG. 6;

FIG. 8 is a top plan of the cam of FIG. 3;

FIG. 9 is a side elevation of the cam of FIG. 3;

FIG. 10 is a bottom plan of the cam of FIG. 3;

FIG. 11 is an enlarged partial perspective view of the handle of FIG. 3 illustrating the key;

FIG. 12 is a perspective view of another embodiment of a quick release assembly, in accordance with the principle of the invention;

FIG. 13 is a sectional view of the quick release assembly of FIG. 12;

FIG. 14 is a fragmented perspective view of yet another embodiment of a quick release assembly, in accordance with the principle of the invention; and

FIG. 15 is a sectional view of a cam of the quick release assembly of FIG. 14 with a key of a handle thereof depicted adjacent the cam.

### DETAILED DESCRIPTION OF PREFERRED EMBODIMENTS

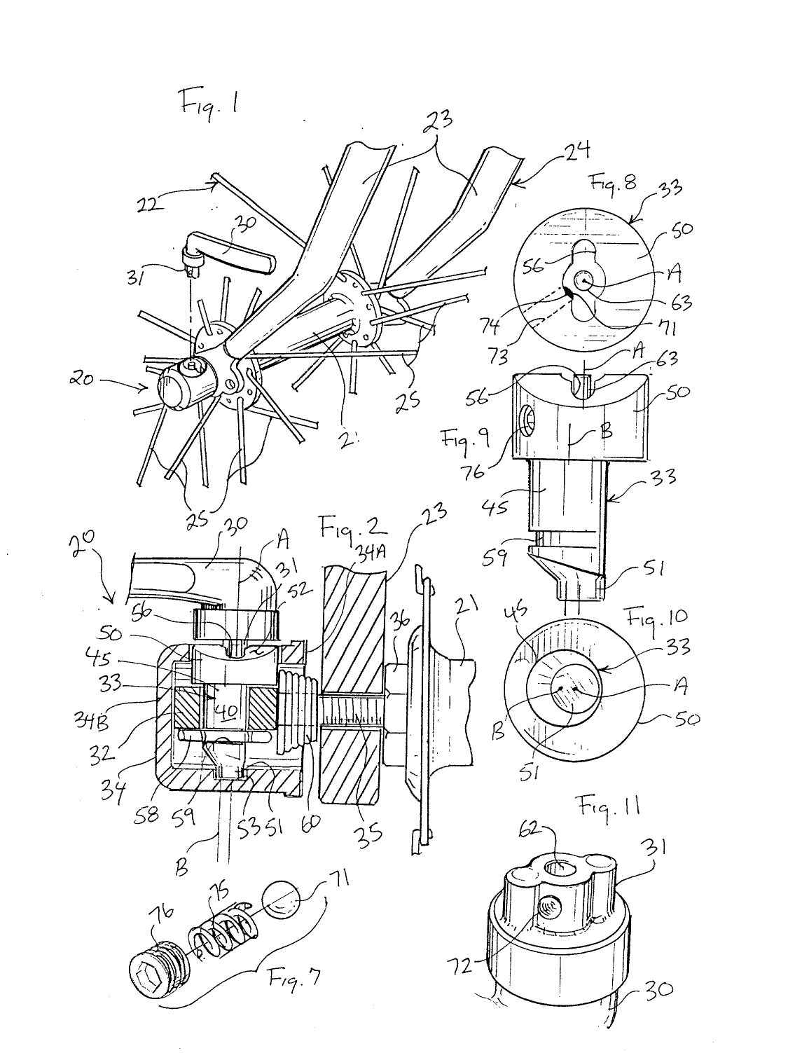

Turning now to the drawings, in which like reference characters indicate corresponding elements throughout the several views, attention is first directed to FIG. 1 in which is seen a perspective view of a quick release assembly 20, embodying the principle of the invention. Assembly 20 is disposed with a hub 21 that is attached to a wheel 22 and to a fork 23 of a frame 24, each partially depicted. In FIG. 1, frame 24 is a bicycle frame of a bicycle, fork 23 is the front fork of frame 24 and wheel 22 is the front wheel of the bicycle. Hub 21 is attached to spokes 25 of wheel 22 in a conventional manner.

Looking to FIGS. 2 and 3, assembly 20 includes handle 30 having a key 31, a piston 32 having a bore 40, a cap 34 having an open end 34A and a closed end 34B, a cam 33 held by cap 34 for rotation in bore 40 and having a keyway 56 that is capable of receiving key 31, and a catch assembly 70 (FIG. 3). FIG. 4 is a side elevation of handle 30, the opposite side elevation being a mirror image thereof. FIG. 5 is a bottom plan of handle 30. With specific regard to FIG. 2, a hollow axle 35 extends through hub 21. A nut 36 threadably secures axle 35 to hub 21, and assembly 20 attaches to axle 35 immediately adjacent fork 23. Open end 34A of cap 34 is directed toward fork 23, and closed end 34B of cap 34 is directed away from fork 23. An axle 37 is slideably disposed through axle 35 and, in this embodiment, is attached to piston 32. Axle 37 is capable of reciprocating through axle 35 and is considered reciprocated to hub 21. Because axle 37 is reciprocated to hub 21, piston 32 is also considered reciprocally mounted. Although not shown, axle 37 extends through and slightly beyond axle 35, and a nut threadably secures this exposed end of axle 37 to fork 23. Bore 40 extends through piston 32 and cap 34 fits over and surrounds piston 32. Cam 33 is rotatably disposed through bore 40 and is rotated to cap 34. Included in cam 33 is a cam body 45 that is rotatably disposed through bore 40 of piston 32. The outer diameter of cam body 45 that extends through bore 40 is slightly less than the inner diameter of bore 40, and this permits cam body 45 to rotate within bore 40. Cam body 45 has opposing ends 50,51 disposed on either side of piston 32 that are held by cap 34 for rotation. End 50 extends into and is held for rotation by an opening 52 of cap 34 and end 51 extends into and is held for rotation by a recess 53 of cap 34 opposing opening 52. End 51 can be fashioned with a recess and cap 34 can be fashioned with an extension or protuberance for rotatably accommodating the recess of end 51 if desired. A clamp 58 located adjacent the underside of piston 32 attaches and secures an annular groove 59 formed into cam 33 proximate end 51, which, in cooperation with piston 32, secures piston 33 to cap 34 preventing it from discharging through opening 52.

End 50 of cam 33 is cylindrical and enlarged relative to cam body 45, and this is readily visualized in FIGS. 2 and 3. End 50 is capable of being rotated in opening 52 and defines an axis of rotation A (FIGS. 2,9,10) that is substantially concentric with the geometric center of opening 52 (FIG. 2). Keyway 56 extends into end 50 and defines a geometric center that is substantially concentric with axis of rotation A, as defined by end 50. Accordingly, the geometric center of keyway 56 is eccentric to cam body 45 and, more particularly, to axis of rotation B. End 50 is considered a key receiving member of cam 33. Cam body 45 is capable of being rotated in bore 40 at its axis of rotation B (FIGS. 2,9,10), which is substantially concentric with the geometric center of bore 40 and eccentric to the geometric center of opening 52. As a result, the geometric center of bore 40 is eccentric to the geometric center of opening 52. A spring 60 is located between fork 23 and piston 32, encircles axle 37 and biases piston 32 away from fork 23 and otherwise toward cap 34.

To secure wheel 22 to fork 23, a cyclist takes up handle 30 and inserts key 31 into keyway 56 of cam 33 as shown in FIG. 2. Rotation of handle 30 rotates cam 33 rotating cam body 45 within bore 40 of piston 32 causing piston 32, cam 33 and cap 34 to move. By selectively rotating cam 33, assembly 20 is capable of being moved between an open position releasing fork 23 and a closed position securing fork 23. In the open position of assembly 20, cap 34 is disposed away from fork 23 allowing removal of wheel 22. In the closed position of assembly 20, end 34A of cap 34 bears tightly up against fork 23 preventing removal of wheel 22.

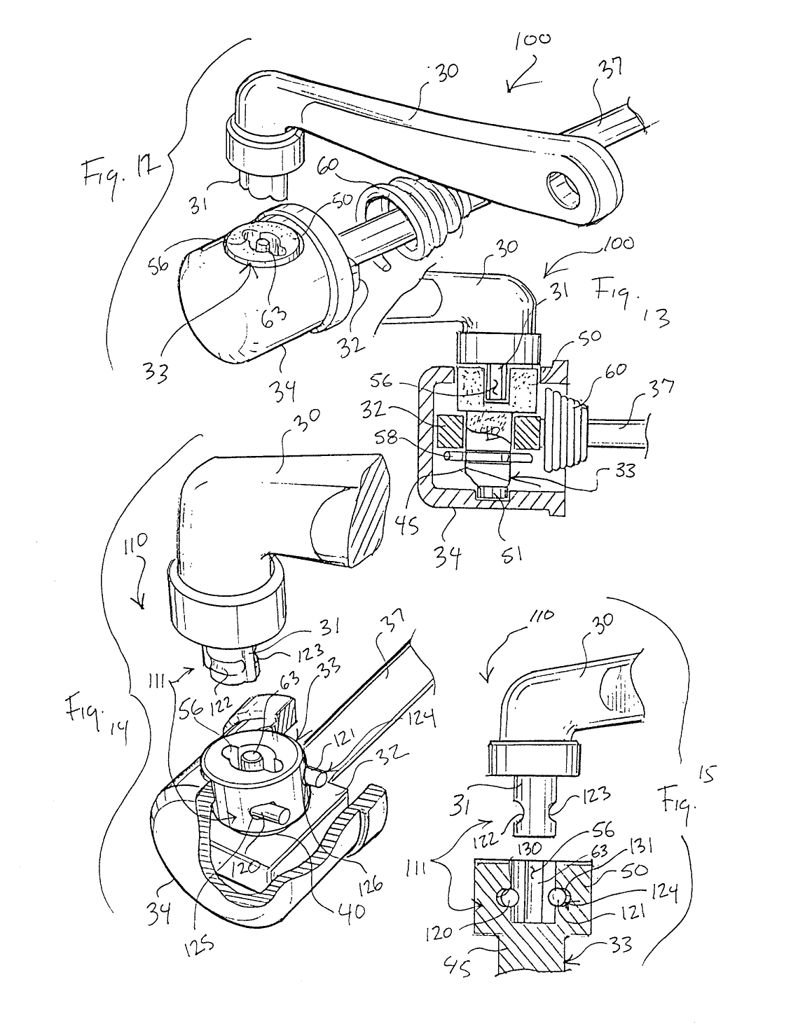

Handle 30 is not provided with an attached cam as with prior art quick release assemblies, but is provided with key 31, which permits handle 30 to function not only to rotate cam 33 as previously explained but also to lock assembly 20 to prevent the likelihood of theft of wheel 22. With regard to FIG. 11, key 31 demonstrates a specific shape and keyway 56 (FIGS. 3,9) is correspondingly shaped to accept key 31. Key 31 and keyway 56 can embody a potentially infinite variety of complementing shapes. In the immediate embodiment, a central blind bore 62 extends into key 31, which is capable of accepting a guide pin 63 disposed centrally of keyway 56.

When assembly 20 is in its closed position securing fork 23, removing handle from assembly 20 prevents wheel 22 from be stolen because unless one has a handle with a duplicate key rotation of cam 33 is not possible and removal of wheel 22 becomes extremely difficult if not impossible. Handle 30 usually removed from assembly 20 when the bicycle is unattended. When the bicycle incorporating assembly 20 is in use, most cyclists prefer to keep handle 30 attached to assembly 20. However, it has been noticed that because there is nothing locking handle 30 to assembly 20, handle 30 is free to fall away from assembly 20, causing it to be lost. In accordance with the principle of the invention, key 31 and cam 33 are furnished with catch assembly 70, which locks key 31 to keyway 56, preventing key 31 from inadvertently falling away from keyway 56 except with a force that is sufficient to overcome the locking action of catch assembly 70.

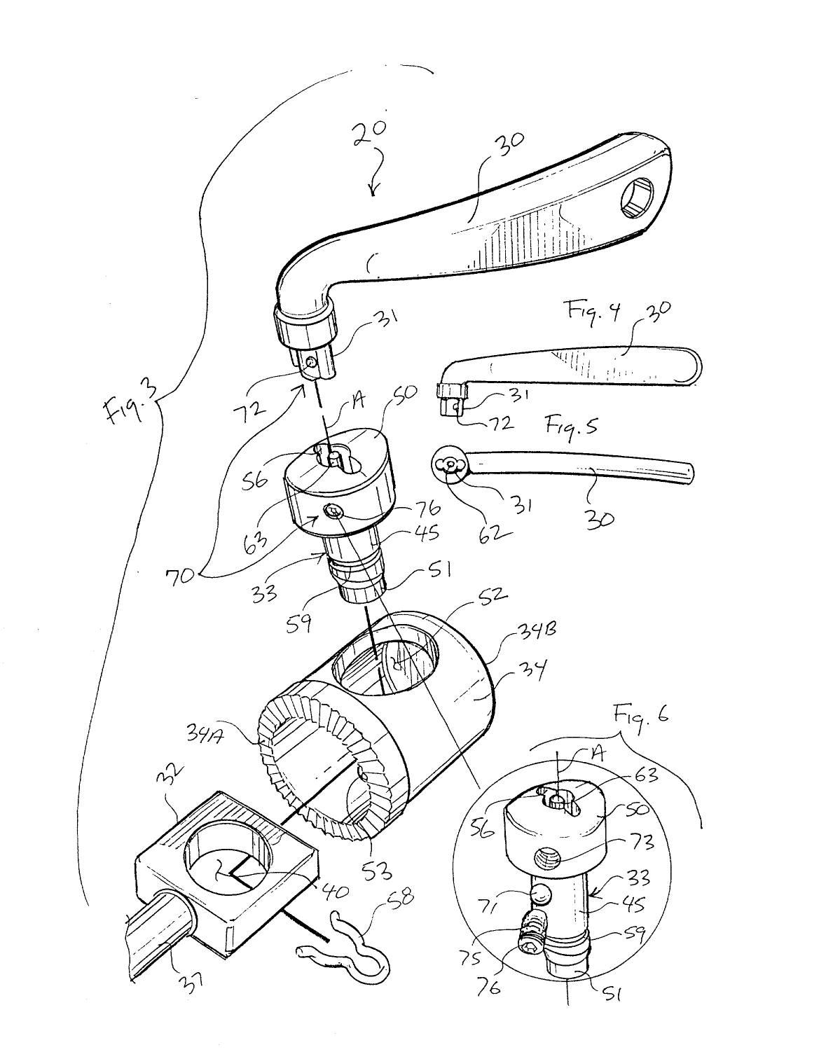

In the immediate embodiment, catch assembly 70 includes a protuberance 71 (FIGS. 6-8) carried by cam 33 and a detachably engageable recess 72 (FIGS. 3,4,11) carried by key 31. Regarding FIG. 6, a bore 73 extends through end 50 of cam 33 to an opening 74 (FIG. 8) leading to keyway 56. Protuberance 71 is located at opening 74, and although opening permits protuberance 71 to extend partially into keyway 56 as depicted in FIG. 8, opening 74 is too small to permit protuberance to fall away from bore 74 into keyway 56. A spring 75 is captured in bore 73 between protuberance 71 and a nut threadably attached to the outer opening leading to bore 73. Spring 75 bears against nut 76 and protuberance 71 and biases protuberance toward or otherwise into keyway 56. Key 31 encounters protuberance 71 when inserted into keyway 56. Exerting a force against key 31 toward keyway 56 that is sufficient to overcome the bias of spring 75 allows key 31 to push protuberance 71 away from keyway 56 forcing it into bore 73 allowing key 31 to pass thereby into keyway 56 until the point when protuberance 71 encounters recess 72. When protuberance 71 encounters recess 72, the bias provided by spring 75 forces protuberance 71 into engagement into and against recess 72 securing key 31 to cam 33, securing handle 30 to cam 33 to prevent handle 30 from inadvertently falling away from cam 30. In this way, a bicycle incorporating assembly 20 can be used and ridden with handle 30 attached without risk of handle 30 inadvertently becoming detached from cam 33. The only way to remove handle 30 is to reverse the foregoing operation by taking up handle 30 and pulling on it with a force that is sufficient 31 to overcome the bias provided by spring 75, detaching protuberance 71 from recess 72. The positioning of protuberance 71 and recess 72 can be reversed, with recess 72 carried by cam 33 at keyway 56 and protuberance 71 carried by key 31 in a fashion like that of cam 33 so as to extend outwardly of, and be biased away from, key 31. Also, although only one protuberance and complementing recess are immediately depicted, any reasonable number of protuberances and complementing recesses can be employed if desired.

In sum, when key 31 is inserted into keyway 56 and protuberance 71 engages recess 72, handle 30 is prevented from falling out of assembly 20. Accordingly, a cyclist can use the bicycle with handle 30 in place. When the cyclist wants to park the bicycle and remove the front wheel, handle 30 may be used to release the wheel from the fork. However, if the cyclist removes handle 30 while the wheel is locked in place to the fork, it would be extremely difficult for someone without the key to remove the wheel.

Attention is now directed to FIGS. 12 and 13, in which there is seen an alternate embodiment of a quick release assembly of the invention, generally designated by the reference character 100. In common with the previously described embodiment designated 20, the immediate embodiment shares handle 30, key 31, piston 32, bore 40 (FIG. 13), axle 37, cap 34, cam 33 including cam body 45 and ends 50 and 51 and keyway 56, clamp 58, spring 60, pin 63 and other common structural components. However, cam 33 is fabricated of magnetic material and key 31 is fabricated of iron or steel. The magnetism of cam 33 has the property of attracting key 31. In this way, a bicycle incorporating assembly 100 can be used and ridden with handle 30 attached without risk of handle 30 inadvertently becoming detached from cam 33, with the magnetic coupling or engagement between key 31 and cam 33 functioning to prevent handle from inadvertently becoming detached from cam 33. The only way to remove handle 30 is to pull on it with a force that is sufficient 31 to overcome the magnetic attraction between key 31 and cam 33, detaching key 31 from cam 33. Key 31 can be constructed from magnetic material and cam 33 from iron or steel if desired. Also, key 31 and cam 33 can each be constructed from magnets if desired for increasing the magnetic attraction between them. The magnetic attraction/engageability between key 30 of handle 30 and cam 33 is considered an alternate embodiment of a catch assembly of the invention. Because key 31 is considered part of handle 30, the magnetic coupling attribute of assembly 100 is considered between and facilitated by handle 30 and cam 33.

In sum regarding assembly 100, when key 31 is inserted into keyway 56 and key 31 of handle 30 is magnetically coupled to cam 33, handle 30 is prevented from falling out of assembly 100. Accordingly, a cyclist can use the bicycle with handle 30 in place. When the cyclist wants to park the bicycle and remove the front wheel, handle 30 may be used to release the wheel from the fork. However, if the cyclist removes handle 30 while the wheel is locked in place to the fork, it would be extremely difficult for someone without the key to remove the wheel.

Attention is now directed to FIGS. 14 and 15, in which there is seen an alternate embodiment of a quick release assembly of the invention, generally designated by the reference character 110. Looking to FIG. 14, and in common with the previously described embodiment designated 20, the immediate embodiment shares handle 30, key 31, piston 32, bore 40, axle 37, cap 34, cam 33 including cam body 45 (FIG. 15), keyway 56, pin 63 and other common structural components. However, assembly 110 is furnished with a catch assembly 111 that includes a pair of protuberances 120,121 carried by cam 33 and a pair of detachably engageable recesses 122,123 carried by key 31. Protuberances 120,121 are elongate, extend into keyway 56 along either side of pin 63 and are the opposing sides of a U-shaped spring 124 attached to cam 33. Spring 124 extends through openings 125,126 formed into and through end 50 of cam 30, which actually blend into recess 130,131 (FIG. 15) located at keyway 56 on either side of pin 63. Protuberances 120,121 reside at recesses 130,131 and are biased toward or otherwise into keyway 56 away from recesses 130,131, respectively. Recesses 122,123 are located on either side of key 31.

Key 31 encounters protuberances 120,121 when inserted into keyway 56. Exerting a force against key 31 toward keyway 56 that is sufficient to overcome the bias of protuberances 120,121 allows key 31 to push protuberances 120,121 away from keyway 56 forcing them into recesses 130,131, respectively, allowing key 31 to pass thereby into keyway 56 until the point when protuberances 120,121 encounter recesses 122,123, respectively. When protuberances 120,121 encounter recesses 122,123, the bias provided by spring 124 forces protuberances 120,121 into engagement into and against recesses 122,123, respectively, clamping and securing key 31 to cam 33, securing handle 30 to cam 33 to prevent handle 30 from inadvertently falling away from cam 30. In this way, a bicycle incorporating assembly 110 can be used and ridden with handle 30 attached without risk of handle 30 inadvertently becoming detached from cam 33. The only way to remove handle 30 is to reverse the foregoing operation by taking up handle 30 and pulling on it with a force that is sufficient 31 to overcome the bias provided by spring 124, detaching protuberances 120,121 from recesses 122,123. The positioning of protuberances 120,121 and recesses 122,123 can be reversed, with recesses 122,123 carried by cam 33 at keyway 56 and protuberances 120,121 (spring 124) carried by key 31 so as to extend outwardly of, and be biased away from, key 31.

In sum, when key 31 is inserted into keyway 56 and protuberances 120,121 engage recesses 122,123, respectively, handle 30 is prevented from falling out of assembly 110. Accordingly, a cyclist can use the bicycle with handle 30 in place. When the cyclist wants to park the bicycle and remove the front wheel, handle 30 may be used to release the wheel from the fork. However, if the cyclist removes handle 30 while the wheel is locked in place to the fork, it would be extremely difficult for someone without the key to remove the wheel.

This specification discloses preferred embodiments of the invention. Those skilled in the art will recognize that although the various preferred embodiments of the invention are particularly useful in connection with bicycle wheels, they can be used for securing other removable parts of a bicycle, namely, bicycle seats to seat posts, seat posts to bicycle frames, etc. Those skilled in the art will further recognize that changes and modifications may be made to the described embodiments without departing from nature and scope of the invention. Accordingly, any such changes and modifications to the preferred embodiments are intended to be included within the scope of the invention as assessed only by a fair interpretation of the ensuing claims.

Having fully described the various embodiments of the invention in such clear and concise terms as to enable those skilled in the art to understand and practice the same, the invention claimed is:

1. Apparatus comprising:
a handle having a key;
a piston having a bore;
a cam having first and second ends held by a cap for rotation in the bore, one of the first and second ends having a keyway capable of receiving the key; and
a catch assembly that is capable of catching the key to the keyway.

2. Apparatus of claim 1, the catch assembly comprising:
a protuberance carried by one of the key and the cam at the keyway; and
a detachably engageable recess carried by the other of the key and the cam.

3. Apparatus of claim 2, wherein the protuberance is biased one of:
a) away from the key; and
b) into the keyway.

4. Apparatus of claim 1, wherein the keyway is disposed off center of the cam.

5. Apparatus of claim 1, wherein the piston is attached to a removable part of a bicycle.

6. Apparatus of claim 1, wherein the piston is attached to a hub.

7. Apparatus of claim 6, wherein the hub is attached to a wheel.

8. Apparatus of claim 6, wherein the hub is attached to a bicycle frame.

9. Apparatus comprising:
a handle having a key;
a piston attached to an axle mounted to a hub, the piston having a bore;
a cam having first and second ends held by a cap for rotation in the bore, one of the first and second ends having a keyway capable of receiving the key; and
a catch assembly that is capable of catching the key to the keyway.

10. Apparatus of claim 9, the catch assembly comprising:
a protuberance carried by one of the key and the cam at the keyway; and
a detachably engageable recess carried by the other of the key and the cam.

11. Apparatus of claim 10, wherein the protuberance is biased one of:
a) away from the key; and
b) into the keyway.

12. Apparatus of claim 9, wherein the keyway is disposed off center of the cam.

13. Apparatus of claim 9, wherein the hub is attached to a wheel.

14. Apparatus of claim 9, wherein the hub is attached to a bicycle frame.

15. Apparatus comprising:
a handle having a key;
a piston attached to an axle mounted to a hub attached to a bicycle wheel, the piston having a bore;
a cam having first and second ends held by a cap for rotation in the bore, one of the first and second ends having a keyway capable of receiving the key; and
a catch assembly that is capable of catching the key to the keyway.

16. Apparatus of claim 15, the catch assembly comprising:
a protuberance carried by one of the key and the cam at the keyway; and
a detachably engageable recess carried by the other of the key and the cam.

17. Apparatus of claim 16, wherein the protuberance is biased one of:
a) away from the key; and
b) into the keyway.

18. Apparatus of claim 15, wherein the keyway is disposed off center of the cam.

19. Apparatus of claim 15, wherein the hub is attached to a bicycle frame.

20. Apparatus comprising:
a handle having a key;
a piston having a bore;
a cam having first and second ends held by a cap for rotation in the bore, one of the first and second ends having a keyway capable of receiving the key; and
a magnetic attraction between the cam and the key.

21. Apparatus of claim 20, wherein the keyway is disposed off center of the cam.

22. Apparatus of claim 20, wherein the piston is attached to a removable part of a bicycle.

23. Apparatus of claim 20, wherein the piston is attached to a hub.

24. Apparatus of claim 23, wherein the hub is attached to a wheel.

25. Apparatus of claim 25, wherein the hub is attached to a bicycle frame.

26. Apparatus comprising:
a handle having a key;
a piston having a bore;
a cam having first and second ends held by a cap for rotation in the bore, one of the first and second ends having a keyway receiving the key; and
a magnetic engagement of the key to the cam.

27. Apparatus of claim 26, wherein the keyway is disposed off center of the cam.

28. Apparatus of claim 26, wherein the piston is attached to a removable part of a bicycle.

29. Apparatus of claim 26, wherein the piston is attached to a hub.

30. Apparatus of claim 29, wherein the hub is attached to a wheel.

31. Apparatus of claim 29, wherein the hub is attached to a bicycle frame.

32. Apparatus comprising:
a handle having a key;
a piston attached to an axle mounted to a hub, the piston having a bore;
a cam having first and second ends held by a cap for rotation in the bore, one of the first and second ends having a keyway capable of receiving the key; and
a magnetic attraction between the cam and the key.

33. Apparatus of claim 32, wherein the keyway is disposed off center of the cam.

34. Apparatus of claim 32, wherein the hub is attached to a wheel.

35. Apparatus of claim 32, wherein the hub is attached to a bicycle frame.

36. Apparatus comprising:
a handle having a key;
a piston attached to an axle mounted to a hub attached to a bicycle wheel, the piston having a bore;
a cam having first and second ends held by a cap for rotation in the bore, one of the first and second ends having a keyway capable of receiving the key; and
a magnetic attraction between the cam and the key.

37. Apparatus of claim 36, wherein the keyway is disposed off center of the cam.

38. Apparatus of claim 36, wherein the hub is attached to a bicycle frame.
